(19) United States
(12) Patent Application Publication
(10) Pub. No.: US 2007/0109457 A1
(43) Pub. Date: May 17, 2007

(54) Organic thin film transistor array panel

(75) Inventors: Keun-Kyu Song, Yongin-si (KR); Seung-Hwan Cho, Suwon-si (KR)

Correspondence Address: MACPHERSON KWOK CHEN & HEID LLP, 2033 GATEWAY PLACE, SUITE 400, SAN JOSE, CA, 95110, US

(73) Assignee: Samsung Electronics Co., Ltd.

(21) Appl. No.: 11/599,907

(22) Filed: Nov. 14, 2006

(30) Foreign Application Priority Data
Nov. 16, 2005 (KR) 10-2005-0109659

(51) Int. Cl. G02F 1/136

(52) U.S. Cl. 349/44

(57) ABSTRACT

An OTFT array panel comprises a substrate; a data line formed on the substrate; a source electrode connected to the data line; a drain electrode including a portion facing the source electrode; a first organic semiconductor partially overlapping the source electrode and the drain electrode; a first gate insulating member formed on the first organic semiconductor; a blocking member formed on the first gate insulating member; a pixel electrode formed on the same layer as the blocking member and connected to the drain electrode; a gate line including the gate electrode, intersecting the data line, and formed on the blocking member and a method of manufacturing the same.

### CROSS-REFERENCE TO RELATED APPLICATION

This application claims priority to and the benefit of Korean Patent Application No. 10-2005-0109659 filed in the Korean Intellectual Property Office on Nov. 16, 2005, the contents of which are incorporated herein by reference.

### FIELD OF THE INVENTION

The present invention relates to an organic thin film transistor array panel and a manufacturing method therefor.

### DESCRIPTION OF THE RELATED ART

Generally, flat panel displays such as liquid crystal display (LCD), organic light emitting diode displays (OLED display), and electrophoretic display devices include pairs of a plurality of field-generating electrodes and electro-optical activating layers disposed therebetween. The LCD uses a liquid crystal layer and the OLED uses an organic emission layer as the electro-optical activating layer. One of the field-generating electrode pairs is generally connected to a switching element to which electric signals are applied. The electro-optical activating layer displays images by changing the electric signals to optic signals. In flat panel displays, thin film transistors (TFTs) having three terminals are used as the switching elements. Gate lines transmitting scanning signals control the TFTs and data lines transmitting image signals are applied to pixel electrodes via the gated-on switching elements.

Organic thin film transistor (OTFT) employing an organic semiconductor, instead of an inorganic semiconductor such as Si, are being used because they may be formed by a solution process at a low temperature.

### SUMMARY OF THE INVENTION

According to one aspect of the present invention an organic thin film transistor array panel comprises a substrate; a data line formed on the substrate; a source electrode connected to the data line; a drain electrode including a portion facing the source electrode; a first organic semiconductor partially overlapping the source electrode and the drain electrode; a first gate insulating member formed on the first organic semiconductor; a blocking member formed on the first gate insulating member; a pixel electrode formed on the same layer as the blocking member and connected to the drain electrode; and a gate line including the gate electrode, intersecting the data line, and formed on the blocking member.

The blocking member and the pixel electrode may comprise ITO.

The data line and the source electrode may be made of different materials.

The source electrode and the drain electrode may include ITO or IZO.

The OTFT array panel may further comprise an opening exposing a portion of the source electrode and the drain electrode and a partition including a first contact hole exposing a portion of the drain electrode.

The OTFT array panel may further comprise a second organic semiconductor and a second gate insulating member formed in the first contact hole, wherein the pixel electrode is disposed on the second gate insulating member and wherein the second organic semiconductor, the second gate insulating member and the pixel electrode have a second hole smaller than the first contact hole.

The OTFT array panel may further include a connecting member which connects the pixel electrodes to the drain electrodes through the second contact hole. The connecting member may be formed on the same layer as the gate line. The gate electrode may cover the blocking member completely. The OTFT array panel may further comprise a storage electrode disposed on the same layer as the data line.

The drain electrode may include at least some portion partially integrated with a portion partially overlapping the storage electrode.

An interlayer insulating layer may be formed between the drain electrode and the storage electrode.

The OTFT array panel may further include a light blocking film disposed under the organic semiconductor and formed on the same layer as the data line. The gate insulating member may include organic materials.

The OTFT array panel may further include a first passivation member covering the gate electrode.

The OTFT array panel may further include a second passivation member covering the end portion of the gate line.

A method of manufacturing an organic thin film transistor array panel comprises: forming a data line on a substrate; forming an interlayer insulating layer on the data line; forming a source electrode connected to the data line and a drain electrode facing with the source electrode; forming a partition comprising an opening on the source electrode and a contact hole on the drain electrode; forming an organic semiconductor in the opening and the contact hole; forming a gate insulating layer on the organic semiconductor; forming a blocking member and a pixel electrode on the gate insulating layer; etching the gate insulating layer and the organic semiconductor using the blocking member and the pixel electrodes as a mask; and forming a gate conductor including a gate line and a connecting member on the blocking member, the partition and the pixel electrodes.

The formation of the organic semiconductor may comprise reforming a surface of the partition; coating an organic semiconductor layer on the surface of the partition; and disposing an organic semiconductor in a portion where the partition is absent. The reform of the surface of the partition may provide a different water affinity between the portion where the partition is present and the portion where the partition is absent. The portion where the partition is present may be less hydrophilic than the portion where the partition is absent. The reform of the surface of the partition may comprise applying fluorine gas on the surface of the partition to fluoridize the surface of the partition.

The method of manufacturing an organic thin film transistor array panel may further comprise forming a passivation member covering the gate electrode after the formation the gate conductor.

### BRIEF DESCRIPTION OF THE DRAWINGS

The foregoing and other objects, features and advantages of the present invention may become more apparent from a reading of the ensuing description together with the drawing, in which:

FIG. 1 is a layout view of an organic thin film transistor array panel according to an exemplary embodiment of the present invention;

FIG. 2 is a cross-sectional view of the thin film transistor array panel shown in FIG. 1 taken along line II-II;

FIG. 3, FIG. 5, FIG. 7, FIG. 9, FIG. 12 and FIG. 15 are layout views of the organic thin film transistor array panel shown in FIG. 1 and FIG. 2 in intermediate steps of a manufacturing method thereof according to an exemplary embodiment of the present invention;

FIG. 4 is a cross-sectional view of the organic thin film transistor array panel shown in FIG. 3 taken along line IV-IV;

FIG. 6 is a cross-sectional view of the organic thin film transistor array panel shown in FIG. 5 taken along line VI-VI;

FIG. 8 is a cross-sectional view of the organic thin film transistor array panel shown in FIG. 7 taken along line VIII-VIII;

FIG. 10 is a cross-sectional view of the organic thin film transistor array panel shown in FIG. 9 taken along line X-X;

FIG. 11 is a cross-sectional view of the organic thin film transistor array panel shown in FIG. 10 in following step of a manufacturing thereof;

FIG. 13 is a cross-sectional view of the organic thin film transistor array panel shown in FIG. 12 taken along line XIII-XIII;

FIG. 14 is a cross-sectional view of the organic thin film transistor array panel shown in FIG. 13 in following step of a manufacturing thereof;

FIG. 16 is a cross-sectional view of the organic thin film transistor array panel shown in FIG. 15 taken along line XVI-XVI.

### DETAILED DESCRIPTION OF THE EMBODIMENTS

An exemplary embodiment of the present invention will hereinafter be described in detail with reference to the accompanying drawings.

The present invention will now be described more fully hereinafter with reference to the accompanying drawings, in which preferred embodiments of the invention are shown. This invention may, however, be embodied in many different forms and should not be construed as limited to the embodiments set forth herein.

In the drawings, the thickness of layers, films, panels, regions, etc. are exaggerated for clarity. Like reference numerals designate like elements throughout the specification. It will be understood that when an element such as a layer, region or substrate is referred to as being “on” another element, it can be directly on the other element or intervening elements may also be present. In contrast, when an element is referred to as being “directly on” another element, there are no intervening elements present.

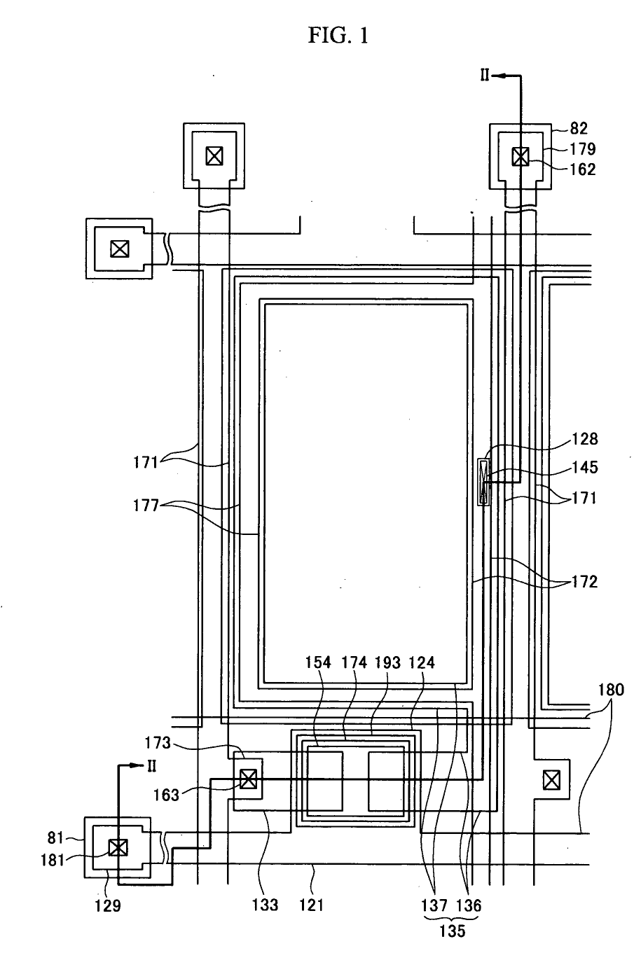

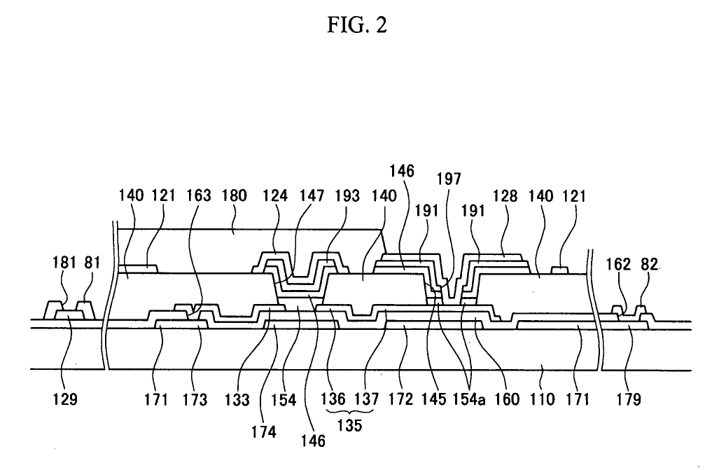

FIG. 1 is a layout view of an organic TFT array panel according to an exemplary embodiment of the present invention; FIG. 2 is a cross-sectional view of the TFT array panel shown in FIG. 1 taken along line II-II.

A plurality of data lines 171, a plurality of storage electrode lines 172 and a plurality of light blocking members 174 are formed on an insulating substrate 110 made of a transparent insulating material such as glass, silicone, or plastic.

Data lines 171 transmit data signals and extend substantially in a longitudinal direction. Each data line 171 includes a plurality of projections 173 which protrude sideward and a wide end portion 179 for the connection with another layer or an external driving circuit. A data driving circuit (not shown) generating data signals may be mounted on a flexible printed circuit film (not shown) attached to, directly mounted on, or integrated with substrate 110. Data lines 171 may extend to and be directly connected to the data driving circuit when the circuit is integrated on the substrate 110.

Storage electrode lines 172 extend substantially parallel to data lines 171 and receive a predetermined voltage. Each storage electrode line 172 is disposed between two data lines 171 and is closer to the right-hand one of the adjacent data lines. Storage electrode lines 172 have storage electrodes 177 which are branched out from the straight stem and form rectangles along with the straight stem. However, storage electrode lines 172 may have various other shapes and arrangements.

Light blocking members 174 are separated from data lines 171 and storage electrode lines 172.

Data lines 171, storage electrode lines 172, and light blocking members 174 may be made of an aluminum-based metal, such as aluminum (Al) or an aluminum alloy, a silver-based metal, such as silver (Ag) or a silver alloy, a copper-based metal, such as copper (Cu) or a copper alloy, a molybdenum-based metal, such as molybdenum (Mo) or a molybdenum alloy, chromium (Cr), tantalum (Ta), or titanium (Ti). They, however, may have a multi-layered structure that includes two conductive films (not shown) having different physical properties. One of these conductive films is composed of low resistivity metals such as aluminum-based, silver-based, and copper-based metals to reduce signal delay or voltage drop. The other film is preferably made of material such as molybdenum-based metal chromium (Cr), tantalum (Ta), or titanium (Ti), which has good physical, chemical, and electrical contact characteristics with other materials especially indium tin oxide (ITO) or indium zinc oxide (IZO), or good adhesion with the substrate 110. Good examples can be a combination of a lower chromium layer and an upper aluminum (alloy) layer, and a combination of a lower aluminum (alloy) layer and an upper molybdenum (alloy) layer. However, data lines 171 and storage electrode lines 172 may be made of various other metals or conductors.

The lateral sides of data lines 171, storage electrode lines 172 and light blocking members 174 are inclined relative to the surface of substrate 110, the inclination angle ranging from about 30 to about 80 degrees.

An interlayer insulating layer 160 is formed on data lines 171, storage electrode line 172, and the light blocking members. Interlayer insulating layer 160 may be made of an inorganic insulating material such as silicon nitride (SiNx) and silicon oxide (SiO₂), and the thickness may be about from 2,000 Å to 5,000 Å.

Interlayer insulating layer 160 includes a plurality of contact holes 163 and 162 respectively exposing projections 173 of data lines 171 and end portions 179 of data lines 171. A plurality of source electrodes 133, a plurality of drain electrodes 135 and a plurality of contact assistants 82 are formed on interlayer insulating layer 160. Each source electrode 133 has an island-shape and is connected to data line 171 through contact hole 163.

Each drain electrode 135 includes a portion 136 facing source electrode 133 on light blocking member 174 (hereinafter, an electrode portion), and a portion 137 overlapping at least some portion of storage electrode line 172 (hereinafter, a capacitor portion). The electrode portion 136 forms a part of the TFT by facing source electrode 133 and capacitor portion 137 forms a storage capacitor along with storage electrode line 172 to enhance the ability of maintaining the voltage.

Contact assistants 82 are connected to the end portions 179 of data lines 171 through contact holes 162 to protect end portions 179 and enhance the connection between end portions 179 and external devices.

Since source electrodes 133 and drain electrodes 135 must contact the organic semiconductor directly, source electrodes 133 are made of a conductive material which has a similar work function to that of the organic semiconductor. Therefore, the Schottky barrier between the organic semiconductor and the drain electrodes is low. This allows easy injection and movement of carriers. Examples of these conductive materials are ITO and IZO. The thickness of source electrodes 133 and drain electrodes 135 may be from about 300 Å to 1,000 Å.

A partition 140 is formed on the entire surface of the substrate including source electrodes 133, drain electrodes 135, and interlayer insulating layer 160. Partition 140 is preferably made of a photosensitive organic material which can be coated in a liquid state. The thickness of partition 140 may be about from 5,000 Å to 4 μm.

Partition 140 includes a plurality of openings 147 and a plurality of contact holes 145. The openings 147 exposes source electrodes 133, drain electrodes 135 and interlayer insulating layer 160 therebetween. The contact holes 145 expose drain electrodes 135.

A plurality of semiconductor islands 154 and 154a are formed in the openings 147 and the contact holes 145 of partition 140.

The organic semiconductor islands 154 formed in the openings 147 contact source electrodes 133 and drain electrodes 135. The organic semiconductor islands are totally enclosed by partition 140 because their heights are smaller than the depth of the openings 147. Since the organic semiconductor islands 154 are fully enclosed by partition 140, the organic semiconductor islands 154 are protected from chemicals used in the following manufacturing process steps.

Organic semiconductor islands 154 formed in the openings 147 are disposed above light blocking member 174 which prevents incident backlight from directly illuminating the organic semiconductor islands 154. As a result, photo leakage current in the organic semiconductor islands 154 is prevented.

Each organic semiconductor island 154a formed in a contact hole 145 has a contact hole smaller than the contact hole 145. Organic semiconductor islands 154 and 154a may include a high molecular compound or a low molecular compound that is soluble in an aqueous solution or an organic solvent.

Organic semiconductor islands 154 and 154a may include derivatives of tetracene or pentacene and may be made of oligothiophene including four to eight thiophenes connected at the positions 2, 5 of thiophene rings.

Organic semiconductor islands 154 and 154a may include polythienylenevinylene, poly-3-hexylthiophene, polythiophene, phthalocyanine, metallized phthalocyanine, or halogenated derivatives thereof. Organic semiconductor islands 154 may also include perylenetetracarboxylic dianhydride (PTCDA), naphthalenetetracarboxylic dianhydride (NTCDA), or imide derivatives thereof. The organic semiconductor islands 154 may include perylene, coronene, or derivatives having their substituents.

The thickness of organic semiconductor islands 154 and 154a may range from about 300 Å to about 3,000 Å.

A plurality of gate insulating members 146 are formed on the gate organic semiconductor islands 154 and 154a. Gate insulating members 146 are formed larger than openings 147 and contact holes 145. Gate insulating members 146 include a plurality of contact holes that are substantially the same size as those of the organic semiconductor islands 154a.

Gate insulating members 146 are made of an organic or inorganic material having relatively high dielectric constant. Examples of this organic material include polyimide-based compound, polyvinyl alcohol-based compound, polyfluorane-based compound, or a soluble high molecular compound such as parylene-based compound. Examples of this inorganic material include silicon oxide that may have a surface treated with octadecyl-trichloro-silane (OTS) or the like.

A plurality of blocking members 193 and a plurality of pixel electrode 191 are formed on gate insulating members 146.

Blocking members 193 protect gate insulating members 146 and organic semiconductor islands 154, and have substantially the same inclination angle as that of the gate insulating members 146.

Pixel electrodes 191 include another plurality of contact holes 197 which are disposed in contact holes 145 and are smaller than contact holes 145. Accordingly, drain electrodes 135 are exposed through contact holes 197.

Each pixel electrode 191 may overlap gate lines 121 or/and data lines 171 to increase the aperture ratio.

Pixel electrodes 191 receive data voltages from the thin film transistor and generate electric fields in cooperation with a common electrode (not shown) supplied with a common voltage, which determine the orientations of the liquid crystal molecules of the liquid crystal layer (not shown) disposed between the two electrodes. Pixel electrode 191 and the common electrodes from a capacitor referred to as a “liquid crystal capacitor,” which stores applied voltages after the thin film transistor turns off.

A plurality of gate lines 121 and connecting members 128 are formed on pixel electrodes 191 and blocking members 193.

Gate lines 121 transmit gate signals and extend in a substantially horizontal direction and intersect data lines 171 and storage electrode lines 172. Each of gate lines 121 includes a wide end 129 for connection with another layer or an external driving circuit. A gate driving circuit (not shown) for generating the gate signals may be mounted on a flexible printed circuit (FPC) film (not shown), which may be attached to the substrate 110, directly mounted on the substrate 110, or integrated on the substrate 110. Gate lines 121 may extend to and be directly connected to the gate driving circuit when the circuit is integrated on the substrate 110.

Gate electrodes 124 overlap organic semiconductor islands 154 with gate insulating members 146 interposed in between. Gate electrodes 124 are large enough to entirely cover the blocking insulating members 193. Blocking members 193 enhance the adhesion between gate electrodes 124 and gate insulating members 146 to prevent the gate electrodes 124 from lifting away.

Connecting members 128 are large enough to cover contact holes 145 and are connected to pixel electrodes 191 and drain electrodes 135.

Gate lines 121 and connecting members 128 may be formed of the same materials as those of data lines 171 and storage electrodes line 172.

The lateral sides of gate lines 121 and the connecting members 128 are also inclined relatively to the surface of the substrate 110 and the inclination angle thereof preferably ranges from about 30 to about 80 degrees.

Gate electrode 124, source electrode 133, and drain electrode 135 form a thin film transistor along with organic semiconductor island 154. A channel of the thin film transistor is formed on the organic semiconductor island disposed between source electrode 133 and drain electrode 135.

A plurality of passivation members 180 and 81 are formed on gate lines 121 and connecting members 128.

The passivation members 180 are for protecting the organic thin film transistor and may be formed on some portions or the entire surface of the substrate. However, passivation members 180 may be omitted.

Passivation members 81 are formed on the end portions 129 of gate lines 121 and have a plurality of contact holes 181 to allow connection with external circuits. Additionally, passivation members 81 prevent the end portions 129 of gate lines 121 from shorting to each other.

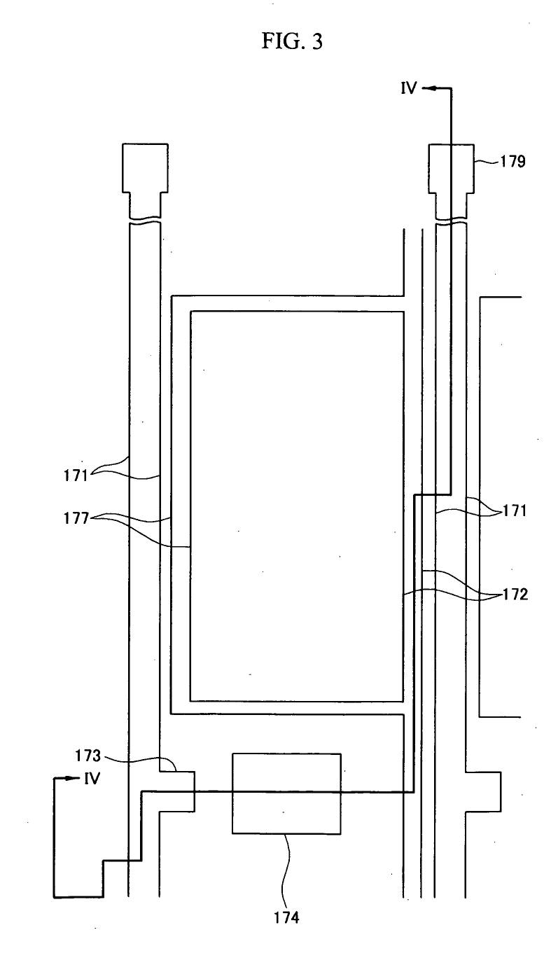

Now, a method of manufacturing the organic TFT array panel shown in FIGS. 1 and 2 will be described in detail with reference to FIGS. 3 to 16.

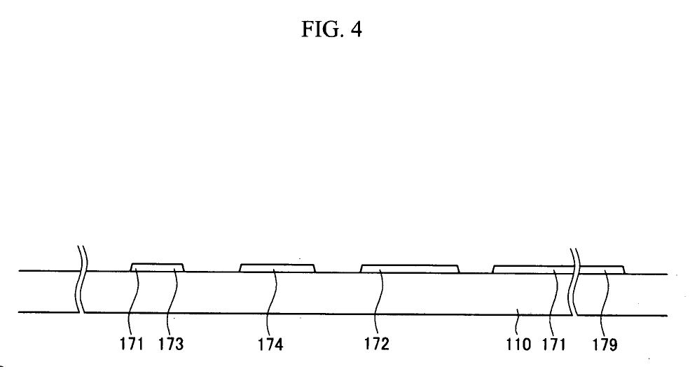

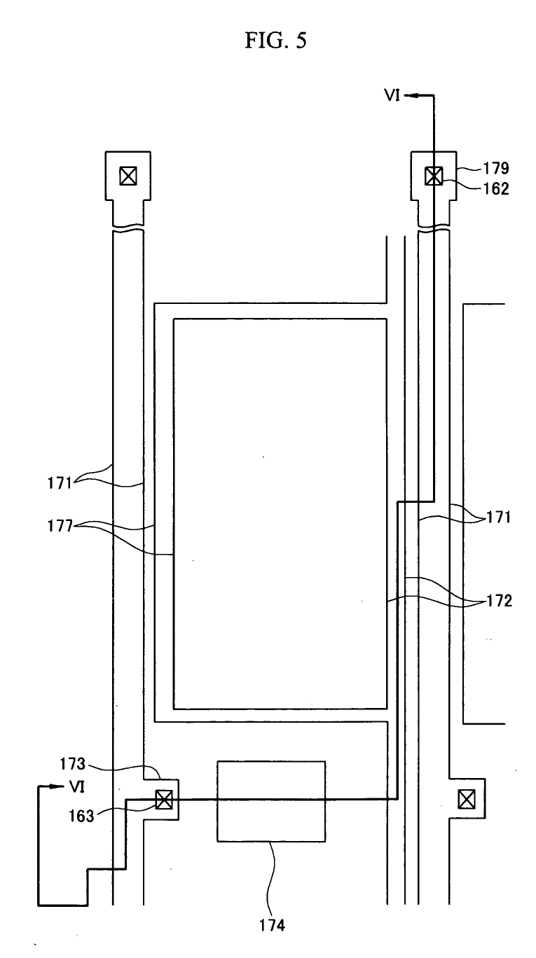

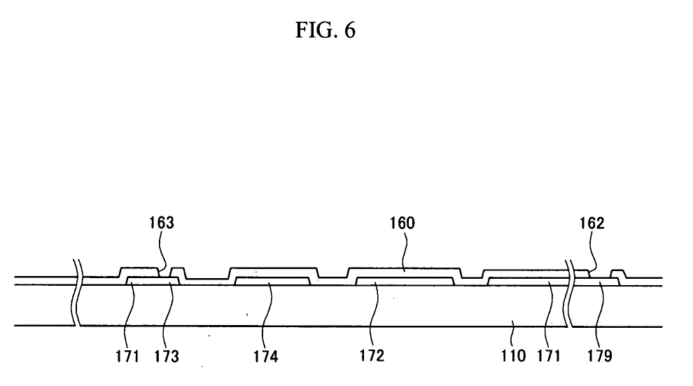

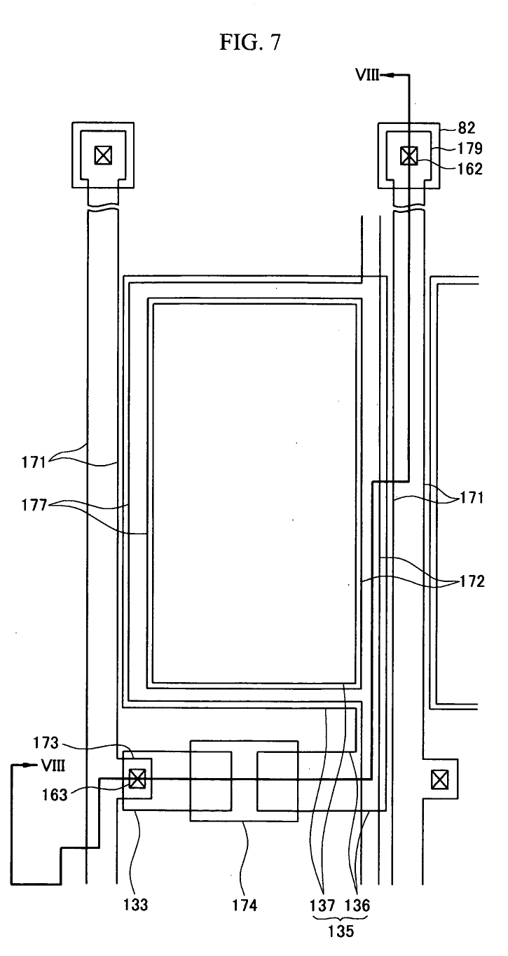

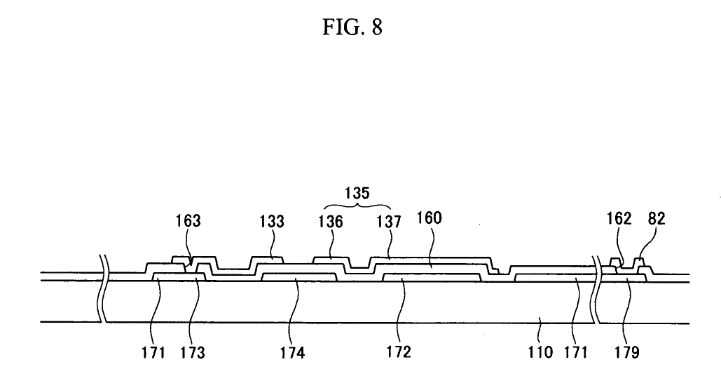

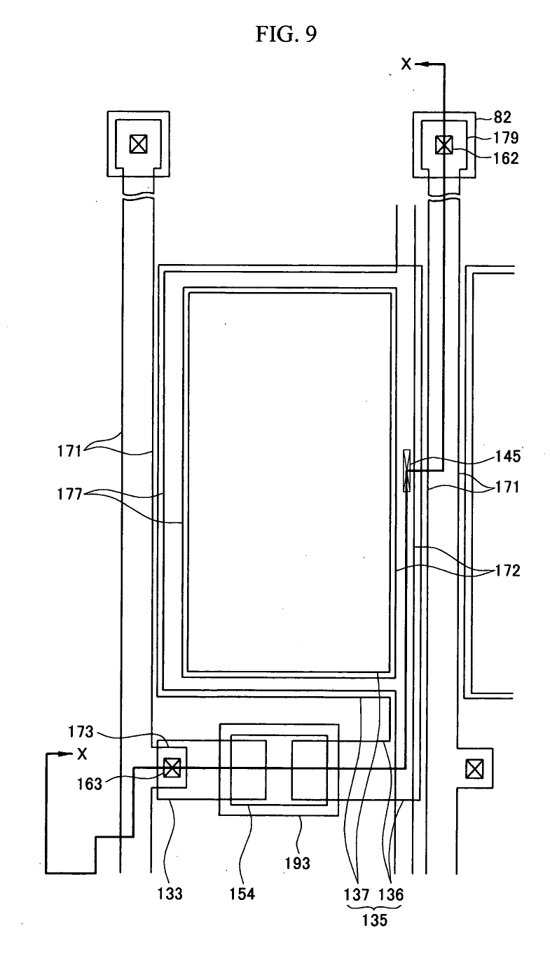

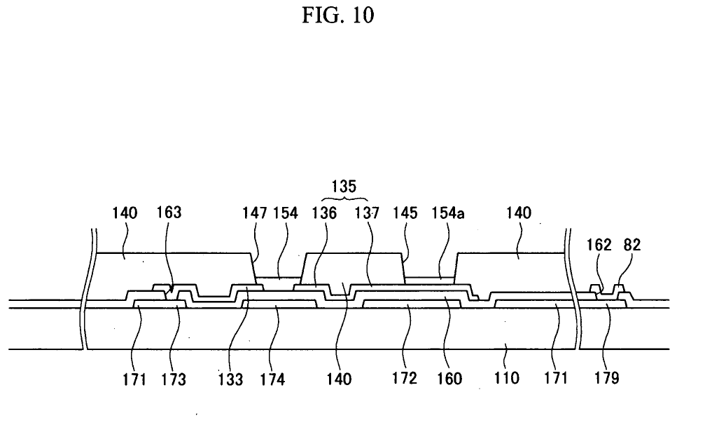

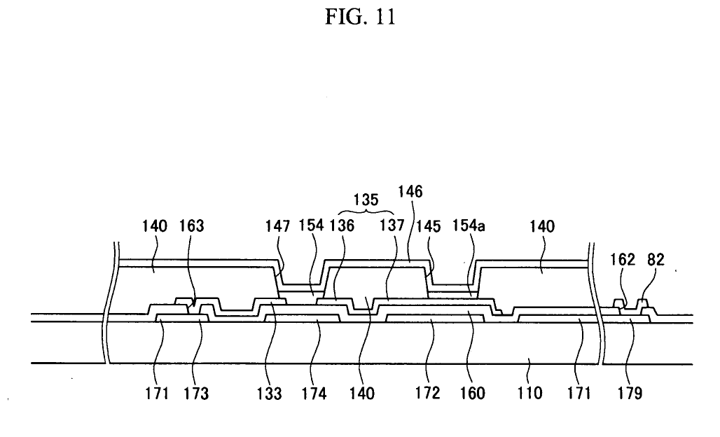

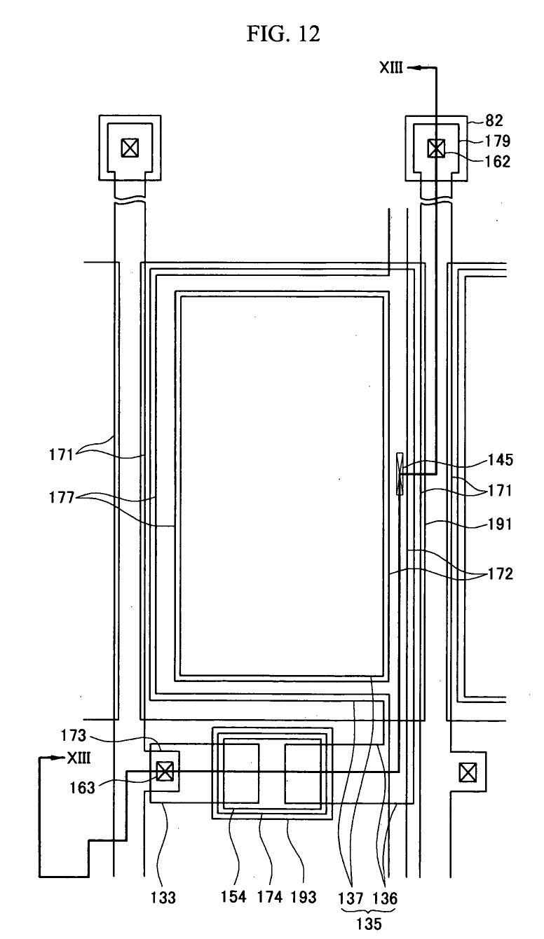

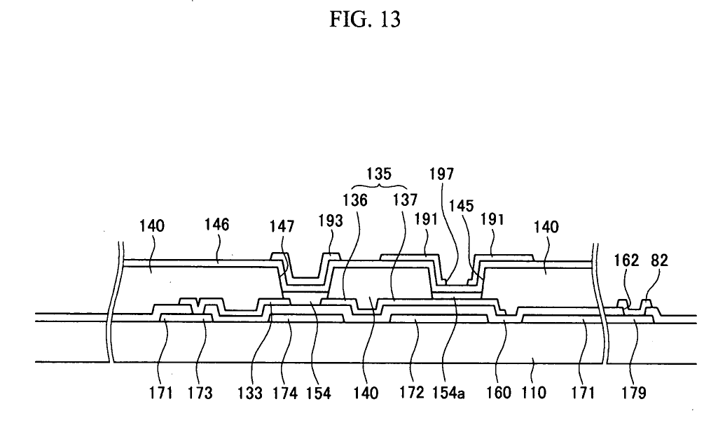

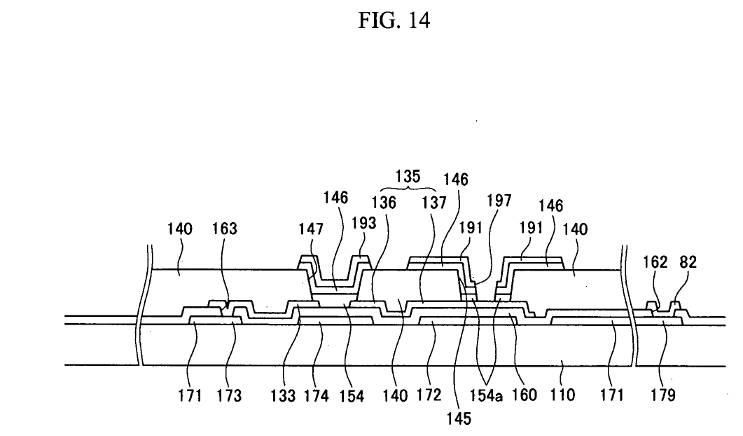

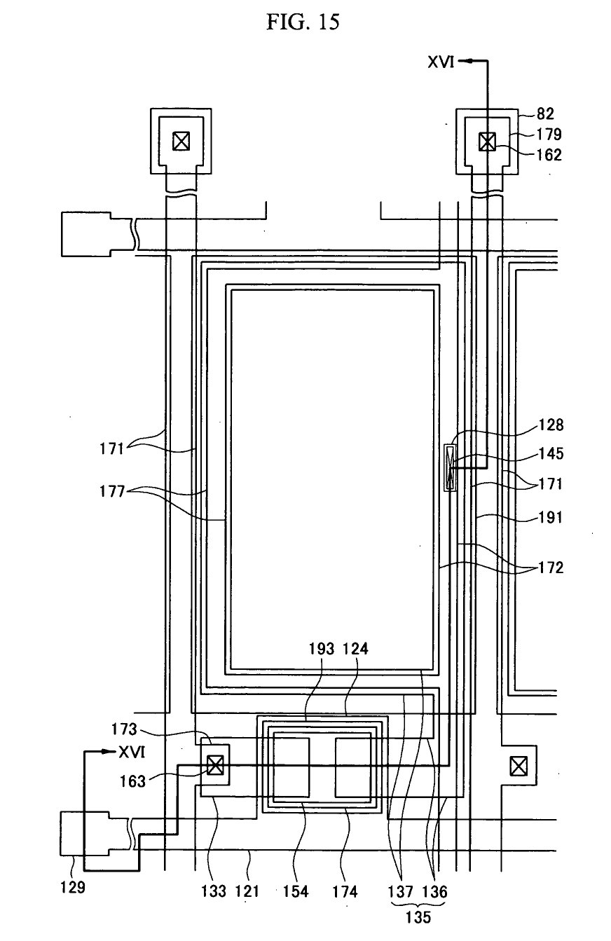

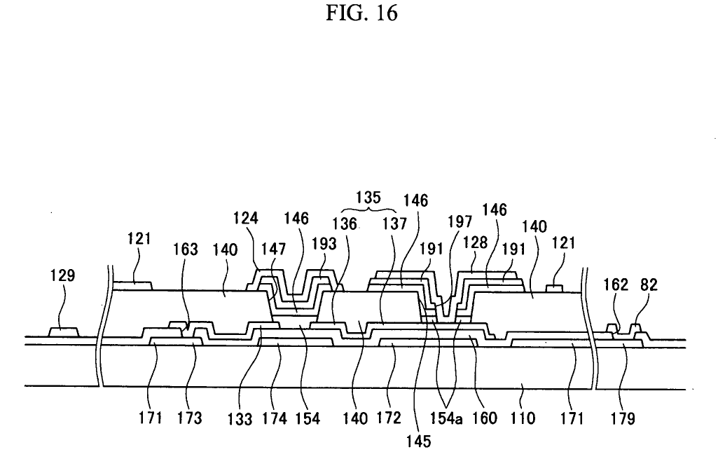

FIGS. 3, 5, 7, 9, 12 and 15 are layout views of the organic TFT array panel shown in FIG. 1 and FIG. 2 in intermediate steps of manufacturing method thereof according to an embodiment of the present invention, FIG. 4 is a cross-sectional view of the organic TFT array panel shown in FIG. 3 taken along line IV-IV, FIG. 6 is a cross-sectional view of the organic TFT array panel shown in FIG. 5 taken along line VI-VI, FIG. 8 is a cross-sectional view of the organic TFT array panel shown in FIG. 7 taken along line VIII-VIII, FIG. 10 is a cross-sectional view of the organic TFT array panel shown in FIG. 9 taken along line X-X, FIG. 11 is a cross-sectional view of the organic TFT array panel shown in FIG. 10 in the step following the step shown in FIG. 10, FIG. 13 is a cross-sectional view of the organic TFT array panel shown in FIG. 12 taken along line XIII-XIII, FIG. 14 is a cross-sectional view of the organic TFT shown in FIG. 13 in the step following the step shown in FIG. 13, FIG. 16 is a cross-sectional view of the TFT array panel shown in FIG. 15 taken along line XVI-XVI.

Referring to FIG. 3 and FIG. 4, a metal layer is deposited on a substrate 110 by sputtering, etc., and patterned by photolithography and etched to form a plurality of data lines 171 including projections 173 and end portions 179, and a plurality of light blocking members 174, and a plurality of storage electrode lines 172 including a plurality of storage electrodes 177.

Referring to FIG. 5 and FIG. 6, interlayer insulating layer 160 may be made of inorganic material and deposited by chemical vapor deposition (CVD), etc. Interlayer insulating layer 160 is patterned by photo-etching to form a plurality of contact holes 162 and 163.

Referring to FIG. 7 and FIG. 8, an ITO or IZO layer is formed by sputtering and patterned by photo-etching to form a plurality of source electrodes 133, a plurality of drain electrodes 135, and a plurality of contact assistants 82.

Referring to FIG. 9 and FIG. 10, a photo sensitive organic layer is coated on the entire surface of the substrate and developed to form a partition 140 having a plurality of openings 147 and a plurality of contact holes 145.

Successively, a plurality of organic semiconductor islands is formed on partition 140.

The organic semiconductor islands 154 may be formed by surface reform. Surface reform is a method to change the surfaces of a material into hydrophilic or hydrophobic by using plasma. First, the surface of partition 140 is reformed. According to the present exemplary embodiment, the surface of partition 140 is treated with fluorine in plasma state. Fluoric gas such as CF₄, C₂F₆ or SF₆ may be supplied with oxygen and/or inert gas in dry etching chamber. In this case, the surface of partition 140 which is made of an organic material is fluoridized through bonding of carbon and fluorine. However, even though source electrodes 133, drain electrodes 135 and interlayer insulating layer 160 are exposed through the openings 147 and the contact holes 145, they are not fluoridized because they are made of inorganic materials. As the surface of partition 140 is fluoridized, the surface of partition 140 is reformed into hydrophobic. On the contrary, the exposed portions through openings 147 and contact holes 145 have a relatively hydrophilic property.

Next, the entire surface of the substrate is spin coated or is slit coated with the organic semiconductor material solved in a solvent. As described above, the surface of partition 140 is hydrophobic and the openings 147 and the contact holes 145 are hydrophilic, the organic semiconductor liquid tends to accumulate into the openings 147 and the contact holes 145.

Finally, after removing the solvent through a drying process, a plurality of organic semiconductor islands 147 are formed in the openings 147 and a plurality of organic semiconductor remnants 154a are also formed in the contact holes 145.

By surface reform, hydrophobic regions and hydrophilic regions are defined to form the organic semiconductor islands 154 on the substrate. This method is simpler than a method using shadow masks. Accordingly, manufacturing time and cost are reduced.

The organic semiconductor islands 154, however, may be formed by an inkjet printing method without using the surface reform method. Next, referring to FIG. 11, a gate insulating layer 146 is formed on the entire surface of the substrate.

Successively, as shown in FIG. 12 and FIG. 13, an ITO layer is sputtered and patterned by photo-etching to form a plurality of blocking members 193 and a plurality of pixel electrodes 191. At this time, the pixel electrodes 191 are patterned to have a plurality of contact holes 197 which are smaller than the contact holes 145 and are disposed in the contact holes 145.

Blocking members 193 and pixel electrodes 191 made of ITO are scarcely damaged by the etching chemicals used in the post-process so that they may be simultaneously formed. Consequently, a lesser number of masks for manufacturing the thin film transistor array panel are used since a mask for separately forming the blocking members 193 is not required.

Referring to FIG. 14, using the blocking members 193 and the pixel electrodes 191 as masks, the gate insulating layer 146 and the organic semiconductor remnants 154a remaining in the contact holes 197 are etched.

Thereafter, referring to FIG. 14 and FIG. 15, a metal layer is deposited by sputtering and patterned by photo-etching to form a plurality of gate lines 121 including a plurality of gate electrodes 124 and a plurality of end portions 129 as well as a plurality of connecting members 128. The gate electrodes 124 are formed in a size to cover the blocking members entirely.

Finally, referring FIG. 1 and FIG. 2, a plurality of passivation members 180 and 81 respectively covering the organic thin film transistor and the end portions 129 of gate lines 121 are formed and they are exposed and developed to form a plurality of contact holes 181 in the passivation members 81.

As described above, the organic semiconductor islands are formed inside the partition and covered by the blocking member thereby preventing the organic semiconductor islands from being affected during post-processing. Additionally, as the source electrode and the drain electrodes are formed with a material having excellent contact characteristics with the organic semiconductor islands, the quality of the organic TFT is improved. Since the blocking members are formed along with the pixel electrodes, a lesser number of masks and processes are required. The method of forming the semiconductor islands is simplified through the surface reform method.

While this invention has been described in connection with what is presently considered to be practical exemplary embodiments, it is to be understood that various modifications and equivalent arrangements will be apparent to those skilled in the art and may be made without, however, departing from the spirit and scope of the invention.

What is claimed is:

1. An organic thin film transistor array panel comprising:
a substrate;
a data line formed on the substrate;
a source electrode connected to the data line;
a drain electrode including a portion facing the source electrode;
a first organic semiconductor partially overlapping the source electrode and the drain electrode;
a first gate insulating member formed on the first organic semiconductor;
a blocking member formed on the first gate insulating member;
a pixel electrode formed on the same layer as the blocking member and connected to the drain electrode; and,
a gate line including a gate electrode intersecting the data line, and formed on the insulating member.

2. The organic thin film transistor array panel of claim 1, wherein the blocking member and the pixel electrode comprise ITO.

3. The organic thin film transistor array panel of claim 1, wherein the data line and the source electrode are made of different materials.

4. The organic thin film transistor array panel of claim 1, wherein the source electrode and the drain electrode comprise ITO or IZO

5. The organic thin film transistor array panel of claim 1 further comprising:
an opening exposing a portion of the source electrode and the drain electrode;
a partition including a first contact hole exposing a portion of the drain electrode.

6. The organic thin film transistor array panel of claim 5, further comprising a second organic semiconductor and a second gate insulating member formed in the first contact hole and wherein the pixel electrode is disposed on the second gate insulating member and the second organic semiconductor, the second gate insulating member and the pixel electrode have a second hole smaller than the first contact hole.

7. The organic thin film transistor array panel of claim 6, further comprising a connecting member connecting the pixel electrode to the drain electrode through the second contact hole.

8. The organic thin film transistor array panel of claim 7, wherein the connecting member is formed on the same layer as the gate line.

9. The organic thin film transistor array panel of claim 1, wherein the gate electrode covers the insulating member completely.

10. The organic thin film transistor array panel of claim 1, further comprising a storage electrode formed on the same layer as the data line.

11. The organic thin film transistor array panel of claim 10, wherein the drain electrode includes at least a portion partially overlapping the storage electrode.

12. The organic thin film transistor array panel of claim 11, wherein an interlayer insulating layer formed between the drain electrode and the storage electrode.

13. The organic thin film transistor array panel of claim 1, further comprising a light blocking film disposed under the organic semiconductor and formed on the same layer as the data line.

14. The organic thin film transistor array panel of claim 1, wherein the gate insulating member comprises an organic material.

15. The organic thin film transistor array panel of claim 1, further comprising a first passivation member covering the gate electrode.

16. The organic thin film transistor array panel of claim 15, further comprising a second passivation member covering the end portion of the gate line.

17. A method of manufacturing an organic thin film transistor array panel comprising:
forming a data line on a substrate;
forming an interlayer insulating layer on the data line;
forming a source electrode connected to the data line and a drain electrode facing the source electrode;
forming a partition comprising an opening on the source electrode and a contact hole on the drain electrode;
forming an organic semiconductor in the opening and the contact hole;
forming a gate insulating layer on the organic semiconductor;
forming a blocking member and a pixel electrode on the gate insulating layer;
etching the gate insulating layer and the organic semiconductor using the blocking member and the pixel electrodes as a mask; and
forming a gate conductor including a gate line and a connecting member on the blocking member, the partition and the pixel electrodes.

18. The method of claim 17, wherein the formation of the organic semiconductor comprises:
reforming a surface of the partition;
coating an organic semiconductor layer on the surface of the partition; and
disposing an organic semiconductor in a portion where the partition is absent.

19. The method of claim 18, wherein the reform of the surface of the partition results in different water affinity between the portion where the partition is disposed and the portion where the partition is absent.

20. The method of claim 19, wherein the portion where the partition is disposed is less hydrophilic than the portion where the partition is absent.

21. The method of claim 18, wherein the reform of the surface of the partition comprises applying fluorine gas on the surface of the partition to fluoridize the surface of the partition.

22. The method of claim 17, further comprising forming a passivation member covering the gate electrode after the formation the gate conductor.
